(19) United States
(12) Patent Application Publication
(10) Pub. No.: US 2015/0075339 A1
(43) Pub. Date: Mar. 19, 2015

(54) Stock Puller

(71) Applicant: Dustin Simpkins, Veneta, OR (US)

(72) Inventor: Dustin Simpkins, Veneta, OR (US)

(21) Appl. No.: 14/029,622

(22) Filed: Sep. 17, 2013

(51) Int. Cl. B23B 13/02

(52) U.S. Cl. CPC B23B 13/022
USPC 82/127

(57) ABSTRACT

A low-cost, easily manufactured stock puller with unibody construction that positions stock on a CNC lathe is provided herein. The stock puller is constructed from a lightweight, yet highly durable material that does not mar the stock as it is being pulled. The stock puller comprises a shank and two jaws that are constructed from the same piece of material. A means for adjusting gripping tension passes through the two jaws which extends the service life of the stock puller by tightening the gripping tension of the jaws. The tightening of the jaws compensates for any loss of gripping tension due to normal wear and tear.

### FIELD OF THE INVENTION

The present invention relates to bar stock feed mechanisms residing within automated lathes, and more specifically, to a unibody stock puller that does not mar the stock and is inexpensive to manufacture.

### BACKGROUND OF THE RELATED ART

Computer Numerical Control (CNC) machines are well known within in the manufacturing industry. Automated CNC machines are capable of performing repetitive yet exacting manufacturing tasks while only requiring occasional maintenance thereby minimizing personnel-related hazards and expenses.

A CNC lathe operates by feeding stock through the machine and tooling the stock to the desired specifications. For ease of use and efficiency, the CNC machine may be self-feeding. Feeding occurs when an attachment on the turret attaches to the stock and pulls the stock into the work chamber. Once in the work chamber, a plurality of tools will begin shaping the stock. Once the work has been completed, the stock puller will once again attach to the stock, exposing the desired amount so work may continue.

Stock-pulling devices are well known within the art. The use of these devices is to removably attach to bar stock and position it within a CNC work chamber. One such method of adhering to stock is to cut a notch into the stock perpendicular to the direction of desired travel. A puller possessing inversely-notched protrusions slides over the stock and enters the notch via tension or mechanical action. The turret then pulls the stock into the work area and the protrusions are removed from the notch. Unfortunately, this embodiment requires the modification of the stock material, and in turn, a loss of material and significant preparation time.

Another embodiment sees a device circular in nature made of a reinforced material with relief cuts in key areas, and an inner diameter just less than the outer diameter of the bar stock. This enables the tool to be force-pressed onto the stock, creating an elastic tension within the reinforced material. This tension creates friction between the stock and the device, enabling the turret to pull stock into the work area. Once the stock is locked into the lathe, sufficient force must be applied to remove the pulling device. A disadvantage of this comes in wear marks on the stock, and wear on the pulling device. Due to the elastic nature of the device, and the materials used in manufacturing, these pullers must be replaced at significantly higher rates, raising costs and downtime.

Another embodiment of the prior art sees finger-like engagement devices which grasp onto the stock creating the necessary gripping friction to advance the stock. These devices can be mechanically or hydraulically actuated, or tension fit. Tension-fit devices see a ramped profile to the distal end of the gripping appendages. When the turret pushes the device onto the bar stock, the ramped end allows the stock to spread the appendages, creating tension within the device, and as such, friction upon the stock. Unfortunately, these impart a great amount of force upon the bar stock, and often leave score marks. Costs must also be considered within these devices, as exact-tolerance units require a great deal of manufacturing precision which raises the costs to the end user.

It could be said there lies a need for an inexpensive, yet durable bar stock pulling device which does not mar stock material, or require the modification of the bar stock.

The present invention meets these needs by providing the user with a bar stock puller made of non-marring composites which uses gripping tension to attach to, and maneuver bar stock within a CNC machine without notching or otherwise modifying the stock.

### BRIEF SUMMARY OF THE INVENTION

The present invention provides a low-cost, easily manufactured stock puller with a unibody construction that positions stock on a CNC lathe. The stock puller is constructed from a lightweight, yet highly durable material that does not mar the stock as it is being pulled. The stock puller comprises a shank and two opposable jaws that are constructed from the same piece of material. A means for adjusting the gripping tension extends the service life of the stock puller by drawing the jaws together when tightened. The drawing together of the jaws compensates for any loss of gripping tension due to normal wear and tear.

Embodiments of the present invention provide a stock puller constructed from a non-marring plastic or composite material with a shank, two jaws, a stock receptacle area between the jaws, and a positive stop that rests approximately 1/32^{nd} of an inch from the end of stock when the stock is pulled. Occasionally, unexpected jarring or kicking of the stock can cause it to shift when being pulled and the positive stop acts as a safety that may contact the stock if such jarring or kicking occurs. The stock puller can be manufactured in different sizes and shapes to accommodate the pulling of different sizes or types of stock. The stock puller can also be manufactured to fit in different types of turrets so that the puller can be used with a multitude of CNC lathe systems.

The preceding brief description is intended to merely outline some functions and advantages of the present invention. The following disclosure will set forth other functions and advantages of the present invention along with novel features that distinguish the present invention from the prior art. It is to be understood that the following disclosure is by no means intended to limit the scope of the present invention or any of its embodiments. It is also to be understood that the accompanying illustrations are presented for descriptive purposes only and similarly are not intended to limit the scope of present invention or any of its embodiments. The following disclosure and accompanying illustrations may describe various features of novelty that characterize the invention. The invention does not reside any particular feature when taken in the singular, but in the combination of features as described herein.

### BRIEF DESCRIPTION OF THE SEVERAL VIEWS OF THE IMAGE(S)

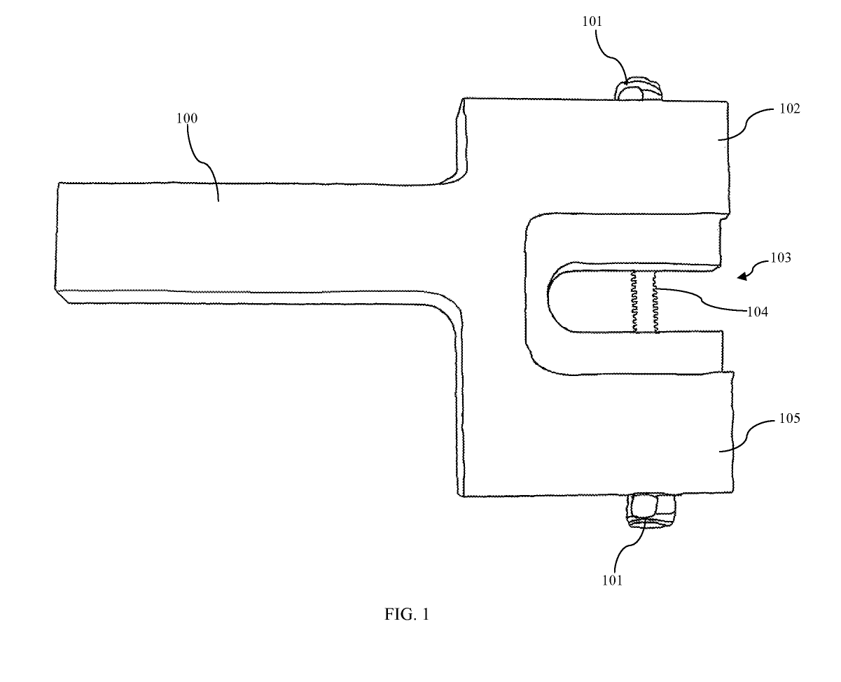

FIG. 1 is a top plan view of a stock puller as according to an embodiment of the present invention;

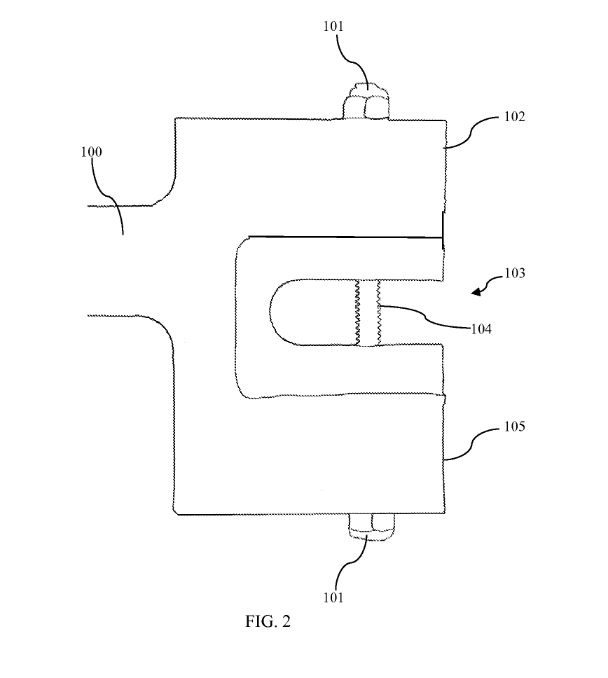

FIG. 2 is a top plan view of the jaws of a stock puller as according to an embodiment of the present invention;

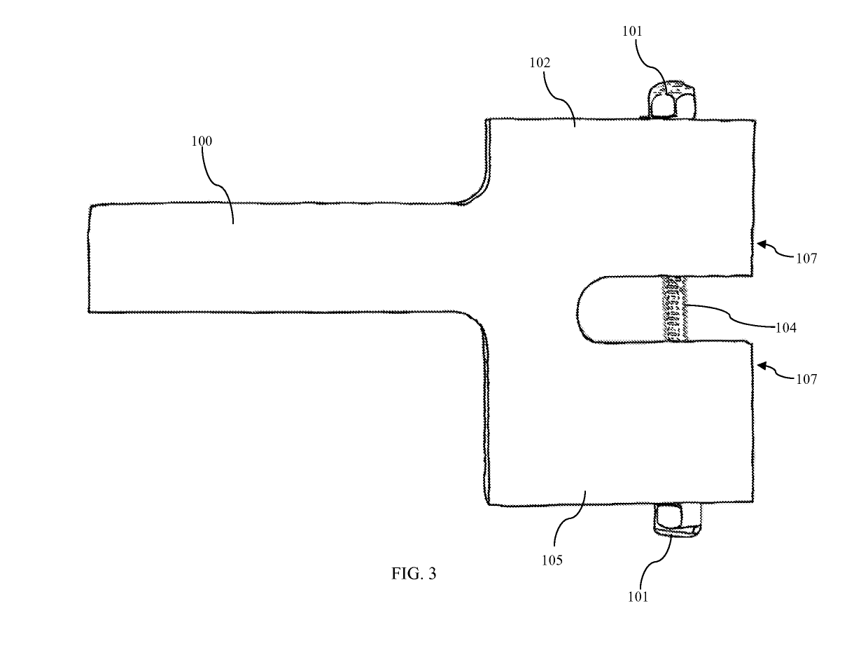

FIG. 3 is a back plan view of a stock puller as according to an embodiment of the present invention;

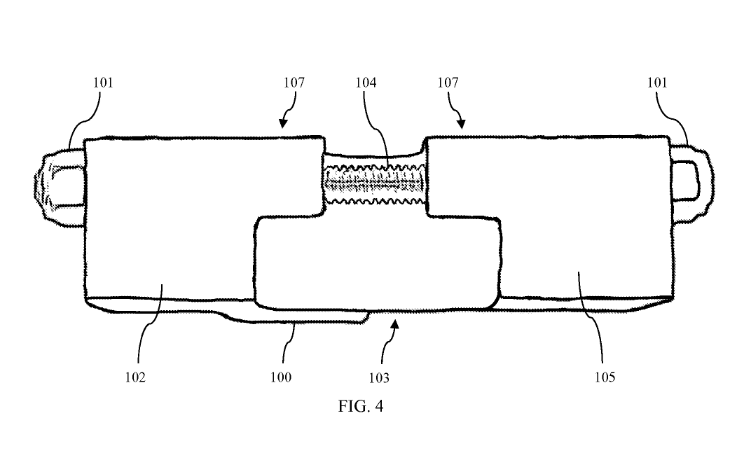

FIG. 4 is a front plan view of a stock puller as according to an embodiment of the present invention;

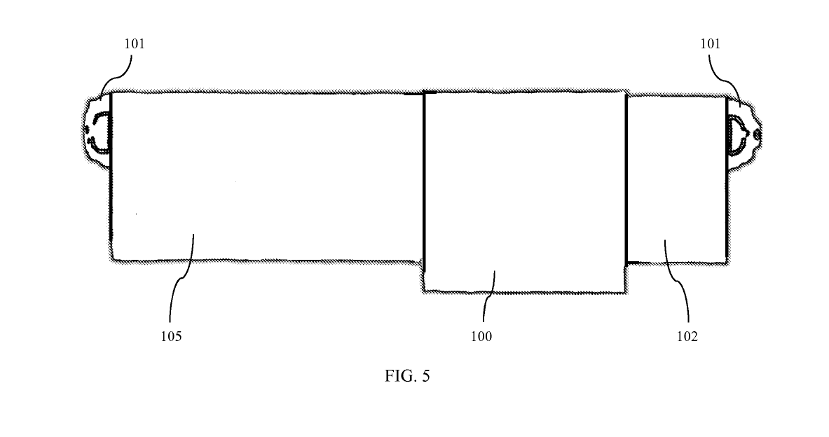

FIG. 5 is a rear plan view of a stock puller as according to an embodiment of the present invention;

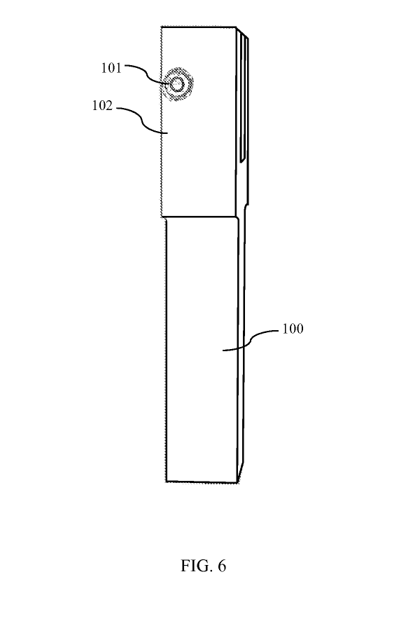

FIG. 6 is a side plan view of a stock puller as according to an embodiment of the present invention;

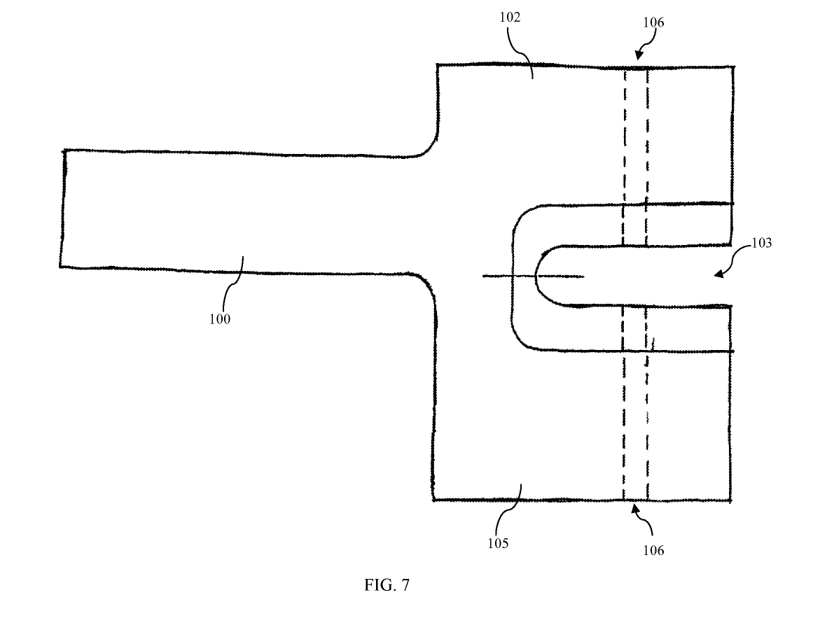

FIG. 7 is a top schematic view of a stock puller as according to an embodiment of the present invention; and

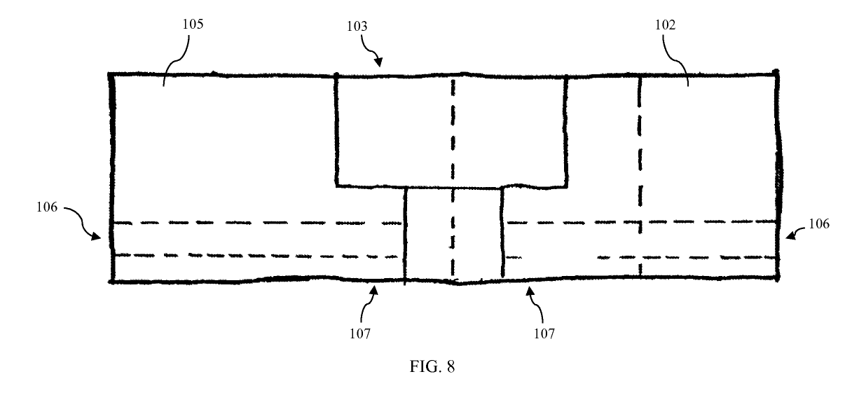

FIG. 8 is a front schematic view of a stock puller as according to an embodiment of the present invention.

### DETAILED DESCRIPTION OF THE INVENTION

In the following detailed description, reference is made to the accompanying images that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with an embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by appended claims, appropriately interpreted, along with the full range of equivalents to which the claims are entitled.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the apparatus include the discussed feature, advantage or mode of operation. The following descriptions of the preferred embodiments are merely exemplary in nature and is in no way intended to limit the invention, its application, or use.

For the purpose of clarity, all like elements will have the same numbering and designations in each of the Figures. The terms “stock puller”, “present invention”, and “invention” may be used interchangeably. In addition to the functions, features, components, and abilities of the apparatus already discussed in this specification, the stock puller may also have, but not be limited to, the following features contained within the description set forth herein.

Several preferred embodiments of the stock puller are discussed in this section. However, the invention is not limited to these embodiments. A stock puller, as according to the present invention, is any device primarily of unibody construction that positions stock on a CNC lathe. The present invention is adjustable, non-marring to the stock, and inexpensive to manufacture.

Referring now to FIGS. 1-2 that will be discussed together, there are shown top plan views of a stock puller as according to an embodiment of the present invention. The stock puller comprises a shank (100) that fits into a turret of a CNC machine. The shank (100) is formed as part of the body of the stock puller and can be made in different sizes to work with different CNC systems. The illustrated shank (100) is square, but embodiments of the present invention include a variety of shank sizes and shapes including round shanks, rectangular shanks, and hex shanks.

An upper jaw (102) and a lower jaw (105) are positioned to form a stock receptacle area (103) between the two jaws (102, 105). The upper jaw (102) and lower jaw (105) are opposable and form a gripping pressure on stock when the stock puller is in use. When used to pull stock, the CNC turret slides the stock puller over the end of stock and into the stock receptacle area (103). The upper jaw (102) and lower jaw (105) grip the stock by exerting a gripping tension on to the end of the stock. The gripping tension is exerted on the stock by way of the stock puller's structural rigidity. The stock puller does not require separate mechanical apparatus such as springs, clamps, or knobs to retain the stock. The retention pressure is of sufficient force to hold the stock as the turret pulls positions the stock for CNC lathe operations. When the stock is in the proper position, the turret detaches the stock puller by retracting the puller off of the end of the stock. The stock remains in position on the CNC lathe and is ready for lathe operations. It should be noted that embodiments of the present invention do not require a groove to be cut in the end of the stock or any other machining of the stock for proper gripping.

A threaded fastener (104) extends through the upper jaw (102) and lower jaw (105) and provides part of a means for adjusting the gripping tension of the stock puller. The threaded fastener (104) draws the upper jaw (102) and lower jaw (105) closer together when either of two end fasteners (101) are tightened. The two end fasteners (101) also form part of the means for adjusting gripping tension of the stock puller. The ability to adjust the gripping tension extends the life of the stock puller by compensating for wear of the upper jaw (102) or lower jaw (105), and for loss of structural rigidity due to repeated use. As more stock is pulled by the present invention, normal wear and tear causes the stock receptacle area (103) to enlarge and the gripping pressure exerted on each piece of stock is slowly lessened. Tightening the end fasteners (101) causes the threaded fastener to draw the upper jaw (102) and lower jaw (105) together thereby reducing the size of the stock receptacle area (103).

Referring now to FIG. 3, there is shown a back plan view of a stock puller as according to an embodiment of the present invention. The back plan view shows the back sides of the opposable upper jaw (102) and the lower jaw (105). The back side of each jaw (102, 105) have a larger surface area than their front sides because they do not have an area cut out to form the stock receptacle area (FIGS. 1, 2, 4, 7, 8 (103)). By not having an area cut out to form the stock receptacle area (FIGS. 1, 2, 4, 7, 8 (103)), the rear portion of each jaw (102, 105) form a positive stop (107) that normally rests 1/32^{nd} of an inch from the end of stock when the stock puller is in use. The positive stop acts as a safety to keep the stock in place if the stock is kicked as may occur when the jaws of a CNC lathe is opened.

Referring now to FIG. 4, there is shown a front plan view of a stock puller as according to an embodiment of the present invention. In this view, it can be seen that the upper jaw (102) and lower jaw (105) face each other in an opposable manner so that stock fits between the jaws (102, 105). It can also be seen that the jaws (102, 105) are stepped to form the stock receptacle area (103) and the positive stop (107). The front, open area of each jaw (102, 105) forms the stock receptacle area (103) and the portions of each jaw immediately behind the stock receptacle area (103) form the positive stop (107). The positive stop (107) rests about 1/32^{nd} of an inch from the end of stock when the stock is pulled and contacts the stock to hold it in place if the stock is inadvertently kicked or jarred. The threaded fastener (104) passes through the portion of each jaw (102, 105) that forms the positive stop (107) so that it does not interfere or contact stock when the stock is pulled.

Referring now to FIG. 5, there is shown a rear plan view of a stock puller as according to an embodiment of the present invention. The shank (100) is attached to the upper jaw (102) and lower jaw (105) in an offset orientation biased toward the upper jaw (102). The exact amount of bias, or whether an offset orientation exists at all, is implementation specific. Embodiments of the present invention include any unibody stock puller with a shank (100) that is positioned in an offset or non-offset position in relation to the upper jaw (102) and lower jaw (105).

The illustrated shank (100) is depicted as square. The scope of the present invention includes shanks (100) that are round, rectangular, or hexagonal. It should be noted that some specialty CNC lathe machines may require the shank (100) of the stock puller to be a shape not mentioned in this description. Embodiments of the present invention include shanks (100) that are any shape that allows them to fit into a turret of a CNC lathe. These embodiments include shanks that are rectangular, hex, octagonal, or any other shape as required to fit into the turret of a CNC machine.

Referring now to FIG. 6, there is shown a side plan view of a stock puller as according to an embodiment of the present invention. An end fastener (101) that forms part of the means for adjusting gripping tension within the stock puller is offset on the upper jaw (102). The threaded fastener (FIGS. 1-4, (104)) passes through the portions of the upper jaw (102) and lower jaw (105) that form the positive stop area (107) of the stock puller. The offset position of the end fastener (101) corresponds to the position of the threaded fastener FIGS. 1-4, (104)) as it passes through the positive stop area (107) of the upper jaw (102) and lower jaw (105).

Referring now to FIG. 7, there is shown a top schematic view of a stock puller as according to an embodiment of the present invention. The schematic view shows a threaded fastener passage (106). The threaded fastener passage is an opening within the stock puller (106) that extends through the upper jaw (102) and lower jaw (105) along their respective positive stop areas (FIGS. 3, 4, 8 (107)). The threaded fastener FIGS. 1-4, (104)) is housed within the threaded fastener passage (106) and is used to adjust the gripping tension of the upper jaw (102) and lower jaw (105). The threaded fastener passage (106) is located below the stock gripping area (103) so that the threaded fastener (FIGS. 1-4, (104)) does not interfere with the pulling of stock when the stock puller is in use.

Referring now to FIG. 8, there is shown a front schematic view of a stock puller as according to an embodiment of the present invention. The threaded fastener passage (106) extends through the positive stop area (107) of the upper jaw (102) and lower jaw (105). When in use, the threaded fastener (FIGS. 1-4, (104)) is housed within the threaded fastener passage (106). The end fasteners (FIGS. 1-6 (101)) attach to the end of the threaded fastener (FIGS. 1-4, (104)) where it protrudes from each jaw (102, 105).

The stock receptacle area (103) is located above the positive stop area (107) and serves to receive stock when a turret positions the stock puller over the end of the stock. The upper jaw (102) and lower jaw (105) provide the gripping force to grip stock when the stock is positioned within the stock receptacle area (103). When the stock is in the proper position on the CNC lathe, the turret retracts the stock puller and machining of the stock commences.

Embodiments of the present invention are constructed from a non-marring, highly durable material that is inexpensive and easy to manufacture. Materials such as rugged plastics, composites, or polymers can be used to form the body. The stock puller has a unibody construction which eliminates the expense of requiring separate components such as additional jaws, springs, clamps and the like which are traditionally used to grip stock. A low-cost means for adjusting gripping tensions, such as a threaded fastener and two end fasteners, extends the life of the stock puller and reduces the effects of normal wear and tear.

The present invention does not require special preparation of stock in order for the stock puller to properly function. No special machining of the stock is needed, no special grooves must be cut within the stock for the stock puller to grip it properly, and the stock puller does not damage stock.

As set forth in this description and the attached images, an improved stock puller has been developed that improves upon conventional stock pullers. The various embodiments of the improved stock puller described herein can be used in a wide variety of applications.

The preceding exemplary embodiments are not intended to be limiting, but are merely illustrative for the possible uses of the stock puller.

Although certain example apparatus and articles of manufacture have been described herein, the scope of coverage of this patent is not limited thereto. On the contrary, this patent covers all apparatus and articles of manufacture fairly falling within the scope of the invention either literally or under the doctrine of equivalents.

With respect to the above description then, it is to be realized that the optimum dimensional relationships for the parts of the stock puller, to include variations in size, materials, shape, form, function and the manner of operation, and use, are deemed readily apparent and obvious to one skilled in the art, and all equivalent relationships to those illustrated in the images and described in the specification are intended to be encompassed by the stock puller.

Directional terms such as “front”, “back”, “in”, “out”, “downward”, “upper”, “lower”, “top”, “bottom”, “lateral”, “vertical” and the like have been used in the description. These terms are applicable to the embodiments shown and described in conjunction with the images. These terms are merely used for the purpose of description in connection with the images and do not necessarily apply to the positions in which the stock puller may be used.

Therefore, the foregoing is considered as illustrative only of the principles of the stock puller. Further, since numerous modifications and changes will readily occur to those skilled in the art, it is not desired to limit the stock puller to the exact construction and operation shown and described, and accordingly, all suitable modifications and equivalents may be resorted to, falling within the scope of the stock puller. While the above description describes various embodiments of the present invention, it will be clear that the present invention may be otherwise easily adapted to fit any configuration where a stock puller is desired or required.

As various changes could be made in the above constructions without departing from the scope of the invention, it is intended that all matter contained in the above description or shown in the accompanying images shall be interpreted as illustrative and not in a limiting sense.

What is claimed is:

1. An apparatus comprising:
a shank that fits into a turret of a Computer Numerical Control (CNC) lathe, an upper jaw and a lower jaw that grip stock machined on the CNC lathe, an area for receiving the stock, an area that forms a positive stop for the stock, and a means for adjusting the gripping tension of the upper jaw and lower jaw; where the shank, upper jaw, and lower jaw are formed from the same piece of material; the area for receiving stock residing between the upper jaw and the lower jaw; the area that forms a positive stop for the stock being a portion of each the upper jaw and the lower jaw; and the means for adjusting the gripping tension of the upper jaw and the lower jaw passes through the upper jaw and the lower jaw.

2. The apparatus of claim 1, wherein the upper jaw and the lower jaw are stepped with one step being the area that receives the stock and the other step being the area that forms the positive stop for the stock.

3. The apparatus of claim 1, wherein the means for adjusting the gripping tension of the upper jaw and the lower jaw comprises a threaded fastener that passes through the upper jaw and the lower jaw and two end fasteners that attach to the ends of the threaded fastener that protrude from the upper jaw and lower jaw.

4. The apparatus of claim 1, wherein the shank is round, rectangular, square, or hexagonal in shape.

5. The apparatus of claim 1, wherein the material that forms the shank, upper jaw, and lower jaw is non-marring.

6. The apparatus of claim 5, wherein the area that forms the positive stop is formed from the same piece of material that forms the shank, upper jaw, and lower jaw.

7. The apparatus of claim 1, wherein the means for adjusting the gripping tension of the upper jaw and the lower jaw passes through the positive stop area of the upper jaw and the lower jaw.

8. A stock puller comprising:
a body constructed of a single piece of material, the body comprising: a shank that fits into the turret of a CNC lathe, an upper jaw and a lower jaw connected to the shank that exert a gripping pressure on a piece of stock that is machined by the CNC lathe, and an area of the upper jaw and the lower jaw that form a positive stop that acts as a safety to hold stock in place if the stock is kicked or jarred during pulling; a means for adjusting the gripping pressure of the upper jaw and the lower jaw, where the means for adjusting the gripping pressure of the upper jaw and the lower jaw passes through the upper jaw and the lower jaw; and an area between the upper jaw and the lower jaw into which the stock fits when the stock puller pulls stock.

9. The stock puller of claim 8, wherein the material used to construct the body is non-marring.

10. The stock puller of claim 8, wherein the position of the shank relative to the upper jaw and the lower jaw is biased toward the upper jaw.

11. The stock puller of claim 8, wherein the shank is round, rectangular, square, or hexagonal in shape.

12. The stock puller of claim 8, wherein are between the upper jaw and the lower jaw into which stock fits is directly adjacent to the area of the upper jaw and lower jaw that form the positive stop.

13. The stock puller of claim 8, wherein the positive stop rests approximately 1/32^{nd} of an inch from the end of stock when the stock puller is used to position stock on the CNC lathe.

14. A unibody stock puller for use with a CNC machine, the unibody stock puller comprising:
a stock puller body including: opposable jaws, each jaw having an area that contacts stock and exerts a gripping pressure on the stock, the gripping pressure being of sufficient force to hold the stock while the stock puller pulls the stock; a shank that allows the stock puller to attach to a turret; and a means for stopping the end of the stock when the stock puller is used to position the stock, the means for stopping the end of the stock being part of each opposable jaw; where the opposable jaws, shank, and means for stopping the end of the stock is formed from a single piece of material; and the unibody stock puller further comprising a means for adjusting the tension of the opposable jaws by drawing together the jaws that is not formed from the single piece of material.

15. The unibody stock puller of claim 14, wherein the area of each jaw that contacts stock and exerts a gripping pressure on the stock is part the area of the jaw that faces the other jaw.

16. The unibody stock puller of claim 14, wherein the means for stopping the end of the stock if the stock is kicked when the stock puller is used to position the stock is an area of each jaw below the area of each jaw that contacts stock and exerts a gripping pressure on the stock.

17. The unibody stock puller of claim 14, wherein the shank is connected to the opposable jaws.

18. The unibody stock puller of claim 14, wherein the turret attaches the stock puller to the stock by sliding the stock puller over the end of the stock so that the jaws of the stock puller contact the stock.

19. The unibody stock puller of claim 14, wherein the means for adjusting the tension of the opposable jaws passes through the opposable jaws in an interior housing within the opposable jaws.

20. The unibody stock puller of claim 14, wherein the single piece of material used to form the opposable jaws, shank and means for stopping the end of the stock is a highly durable, lightweight plastic that does not mar the stock.
